(19) United States
(12) Patent Application Publication
(10) Pub. No.: US 2018/0198855 A1
(43) Pub. Date: Jul. 12, 2018

(54) METHOD AND APPARATUS FOR SCHEDULING CALCULATION TASKS AMONG CLUSTERS

(71) Applicant: ALIBABA GROUP HOLDING LIMITED, George Town, Grand Cayman (KY)

(72) Inventor: Kui WANG, Hangzhou (CN)

(21) Appl. No.: 15/526,789

(22) PCT Filed: Nov. 17, 2014
(86) PCT No.: PCT/CN2015/094790

§ 371 Date: May 15, 2017

(30) Foreign Application Priority Data
Nov. 24, 2014 (CN) 201410681900.7

(51) Int. Cl. H04L 29/08; G06F 9/48; G06F 9/50

(52) U.S. Cl. CPC H04L 67/1008; G06F 9/5083; G06F 9/505; G06F 9/4881

(57) ABSTRACT

The disclosure provides methods and apparatuses for scheduling calculation tasks in a cluster; receive, from the cluster, a plurality of calculation tasks to be scheduled; and divide the plurality of calculation tasks into a plurality of task subsets based on workload information corresponding to the plurality of calculation tasks, wherein each of the plurality of task subsets corresponds to a node of the cluster. Compared with the prior art, each of a plurality of calculation tasks to be scheduled in a cluster is divided into a task subset corresponding to a certain cluster node based on workload information corresponding to the plurality of calculation tasks, so that an optimal matching combination is found for the plurality of calculation tasks to be scheduled in the cluster, so as to utilize resources of the entire cluster to a maximum extent and realize a more reasonable system resource scheduling policy.

### CROSS-REFERENCE TO RELATED APPLICATIONS

This application claims the benefit of priority of Chinese Patent Application No. 201410681900.7, filed on Nov. 24, 2014 and PCT Application No. PCT/CN2015/094790, filed on Nov. 17, 2015, which are incorporated herein in their entirety by reference.

### BACKGROUND

### Technical Field

The disclosure relates to the field of distributed computing, and in particular, to the scheduling of calculation tasks in a cluster of computing devices.

### Description of Related Art

When implementing cloud computing services using the Internet, multiple calculation tasks exist on each cloud service node, and resource isolation is usually required to perform the calculation tasks. These isolated calculation tasks invoke, based on the cloud service node, various resources allocated by an entire cluster.

Currently, the following solutions are adopted in the art.

A first solution is an absolute control method. That is, for a plurality of calculation tasks corresponding to each cloud service node, a resource amount may be allocated based on a total resource amount of the cloud service node itself, and the maximum amount of resources usable by each calculation task is a definite value. In this method, when the amount of resources actually needed by each calculation task is greater than a definite value of the resource amount allocated to the calculation task, the requirements of the calculation task are not met. Conversely, when the amount of resources needed by the calculation task is far less than the definite value of the allocated resource amount, resources are wasted.

A second solution is a relative control method. That is, for a plurality of calculation tasks corresponding to each cloud service node, a resource amount may be allocated to each calculation task based on a certain proportion based on a total resource amount of the cloud service node itself. At this time, when a certain calculation task is under excessive pressure, if the corresponding cloud service node is divided based on weights, the exception of the calculation task will affect the successful operation of other calculation tasks.

### BRIEF SUMMARY

The disclosure provides a method and apparatus for scheduling calculation tasks in a cloud computing cluster.

According to one embodiment, a method for scheduling calculation tasks in a cluster is provided, which includes: receiving, from the cluster, a plurality of calculation tasks to be scheduled; and dividing the plurality of calculation tasks into a plurality of task subsets based on workload information corresponding to the calculation tasks, where each of the task subsets corresponds to one cluster node in the cluster.

According to another embodiment, an apparatus for scheduling calculation tasks in a cluster is further provided, which includes: a first device, configured to receive, from the cluster, a plurality of calculation tasks to be scheduled; and a second device, configured to divide the plurality of calculation tasks into a plurality of task subsets based on workload information corresponding to the calculation tasks, where each of the plurality of task subsets corresponds to a node of the cluster.

Compared with the prior art, according to the disclosed embodiments, each of the plurality of calculation tasks to be scheduled in a cluster is divided into a task subset corresponding to a certain cluster node based on workload information corresponding to the calculation tasks. In this manner, an optimal division combination is identified for the plurality of calculation tasks to be scheduled in the cluster, so as to utilize resources of the entire cluster to a maximum extent and realize a more reasonable system resource scheduling policy.

### BRIEF DESCRIPTION OF THE DRAWINGS

Other features, objects, and advantages of the disclosure will become more apparent from detailed description of non-restrictive embodiments made with reference to the following accompanying drawings:

FIG. 1 is a diagram of an apparatus for scheduling calculation tasks in a cluster according to some embodiments of the disclosure.

FIG. 2 is a flowchart illustrating a method for scheduling calculation tasks in a cluster according to some embodiments of the disclosure,

FIG. 3 is a diagram of a calculation workload of a cluster node M before scheduling according to some embodiments of the disclosure.

FIG. 4 is a diagram of a calculation workload of a cluster node N before scheduling according to some embodiments of the disclosure.

FIG. 5 is a diagram of a calculation workload of the cluster node M after scheduling according to some embodiments of the disclosure.

FIG. 6 is a diagram of a calculation workload of the cluster node N after scheduling according to some embodiments of the disclosure.

The same or similar reference numbers in the drawings represent the same or similar parts.

### DETAILED DESCRIPTION

The disclosure is described in further detail below with reference to the accompanying drawings.

In one embodiment, a terminal, a device of a service network, and a trusted party each include one or more processors (CPUs), input/output interfaces, network interfaces, and memories. The memory may include a computer readable medium in the form of a non-permanent memory, a random access memory (RAM) and/or a non-volatile memory or the like, such as a read-only memory (ROM) or a flash memory (flash RAM). The memory is an example of a computer readable medium. The computer readable medium includes permanent and non-permanent, movable and non-movable media that can achieve information storage by means of any methods or techniques. The information may be computer readable instructions, data structures, modules of programs or other data. Examples of a storage medium of a computer include, but are not limited to, a phase-change memory (PRAM), a static random access memory (SRAM), a dynamic random access memory (DRAM) or other types of random access memories (RAMs), a read-only memory (ROM), an electrically erasable programmable read-only memory (EEPROM), a flash memory or other memory technologies, a read-only compact disc read-only memory (CD-ROM), a digital versatile disk (DVD) or other optical storages, a magnetic cassette, a magnetic tape, a magnetic disk storage or other magnetic storage devices, or any other non-transmission medium that can be used for storing information accessible by a computing device. In light of the definitions herein, the computer readable medium does not include non-transitory computer readable media (transitory media), such as modulated data signals and carrier waves.

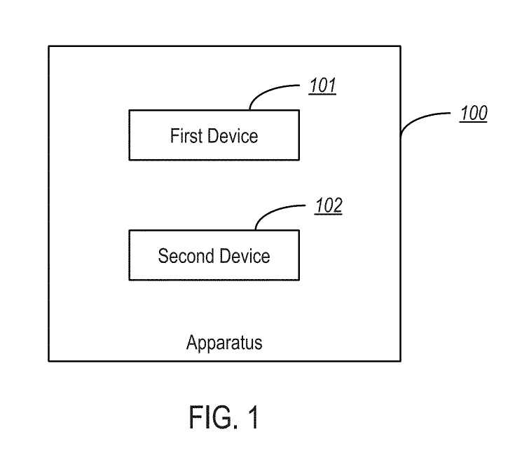

FIG. 1 is a diagram of an apparatus for scheduling calculation tasks in a cluster according to some embodiments of the disclosure. The apparatus (100) for scheduling calculation tasks in a cluster includes a first device (101) and a second device (102).

First device (101) receives, from the cluster, a plurality of calculation tasks to be scheduled. The second device (102) is configured to divide the plurality of calculation tasks into a plurality of task subsets based on workload information associated with the calculation tasks, where each of the plurality of task subsets corresponds to a node of the cluster.

Specifically, the first device (101) of the apparatus (100) receives, from the cluster, a plurality of calculation tasks to be scheduled. In some embodiments, the cluster is a cluster including a plurality of servers configured to perform cloud computing tasks via the Internet. Each server comprises a cluster node providing a service such as cloud computing service to a user. Each of the servers can have several calculation tasks running thereon. Calculation tasks on the cluster node include processes, threads, and the like. The embodiments reschedule and divide a plurality of calculation tasks to a plurality of cluster nodes in a cluster to optimize cluster resource allocation, so it is necessary to determine a plurality of calculation tasks awaiting scheduling. In the embodiments, the larger the resource pool, the greater the number of calculation tasks to be scheduled and the higher the system matching degree of the scheduling. Furthermore the higher the scheduling precision, the more significant the optimization effect of cluster resource allocation.

Additionally, each of the calculation tasks has a corresponding backup calculation task in the cluster (e.g., a cloud resource system) so that data corresponding to the calculation task can be saved, and further, consistency of data between the calculation task and the corresponding backup calculation task is ensured through a synchronization mechanism. By performing backup for disaster recovery on a calculation task, losses caused by emergencies such as damage or loss of data can be avoided.

Those skilled in the art should be able to understand that the plurality of calculation tasks to be scheduled in the cluster that are received by the first device may also come from a third party apparatus other than the apparatus (100). That is, a plurality of calculation tasks to be scheduled are collected from the third party apparatus, and then the apparatus (100) performs corresponding operations such as information processing and task scheduling generation and execution.

Second device (102) of the apparatus (100) divides the plurality of calculation tasks into a plurality of task subsets based on workload information corresponding to the calculation tasks, where each of the task subsets corresponds to one cluster node in the cluster. If an optimal division is to be performed on a plurality of different calculation tasks to maximize utilization of cluster resources, it is foremost required to obtain workload information of the plurality of calculation tasks waiting for scheduling. The workload information includes various measurable index data corresponding to the calculation task, including, but not limited to, attribute indexes related to the calculation task such as a CPU usage rate, a memory usage rate, network usage, memory usage, and network interface traffic. The index data can visually reflect the use and consumption needs of the calculation task for a specific one or more related cluster resources, for example, a corresponding CPU usage rate or memory usage rate required for the running of a single process task. The more a certain type of cluster resource is consumed by the calculation task, the greater the pressure load applied to the cluster node corresponding to the calculation task. Additionally, the workload information may also be a piece of comprehensive, measurable index data formed by combining a plurality of pieces of single and specific measurable index data. For example, a piece of comprehensive index data is generated by calculating single measurable index data, a CPU usage rate, a memory usage rate, and network usage, based on a certain combination, for example, a certain weight is separately set for the CPU usage rate, the memory usage rate, and a network usage parameter based on the actual situation so as to obtain required comprehensive measurable index data.

For example, specific values of all the plurality of calculation tasks to be scheduled based on the same measurable index in the same time period or at the same point in time are analyzed and compared, and a plurality of calculation tasks satisfying an optimal division condition can be divided into the same task subset based on a certain division operation. For example, there may be calculation tasks A, B, C, and D to be scheduled, which respectively belong to cluster nodes 1, 2, 3, and 4. Three calculation tasks (A, B, and C) are selected and divided into one task subset assigned to cluster node 1 based on analyzing respective workload information of the calculation tasks A, B, C, and D, a specific division operation, and the fact that the generation of the new calculation task combination optimizes cluster resource utilization. The service capability of cloud computing provided by cluster resources shows the characteristics of dynamic distribution and real-time change, and workload information used as the source of computing data corresponding to the division operation in this solution can well reflect such dynamic data change. For example, the workload information may be accurate to specific value information corresponding to a definite measurable index in a definite time period or at a definite point in time.

In some embodiments, the first device and the second device may be different devices in the same apparatus. Further, in actual application, this solution may also be implemented by deploying the first device and the second device on different apparatuses.

In some embodiments, each of a plurality of calculation tasks to be scheduled in a cluster is divided into a task subset corresponding to a certain cluster node based on workload information corresponding to the calculation tasks, so that an optimal division combination is found for the plurality of calculation tasks to be scheduled in the cluster, so as to utilize resources of the entire cluster to a maximum extent and realize a more reasonable system resource scheduling policy. In one embodiment, the apparatus (100) for scheduling calculation tasks in a cluster further includes a third device (not shown), and the third device allocates the task subset to the corresponding cluster node and performs (in the cluster node) the calculation tasks in the task subset.

By collecting resource usage of the calculation tasks and then performing task scheduling through a computing engine, system resources corresponding to a certain calculation task will be ready when the Internet user requests the calculation task, and the calculation task can directly use the system resources after scheduling. The plurality of divided calculation tasks are allocated to a corresponding cluster node and share cluster resources through the cluster node. At this time, resources to be consumed while redividing calculation tasks under the cluster node, for example, resources such as network card traffic, CPU, and memory required to be used when the corresponding Internet user requests a certain cloud calculation task, all need to be allocated from a total amount of resources owned by a cluster node corresponding to the cloud calculation task. Therefore, execution of the calculation task is implemented based on the cluster node. In a cloud calculation task, the cluster uses a control system to analyze and collect related data of the cluster nodes and calculation tasks under the cluster nodes and stores the related information in the control system to serve as basic data for developing an information scheduling policy.

Those skilled in the art should be able to understand that the first device, the second device, and the third device may be different devices in the same apparatus. Further, in actual application, this solution may also be implemented by deploying the first device, the second device, and the third device on different apparatuses.

In one embodiment, the second device (102) of the apparatus (100) divides the plurality of calculation tasks into a plurality of task subsets based on workload information corresponding to the calculation tasks, in combination with node resource threshold information corresponding to the cluster, where each of the task subsets corresponds to one cluster node in the cluster.

Specifically, calculation tasks to be scheduled in a cluster are divided into the same task subset, and each task subset corresponds to one cluster node in the cluster. The division operation requires obtaining workload information of the calculation tasks to be scheduled and setting node resource threshold information corresponding to the cluster. In one embodiment, the node resource threshold information includes cluster nodes with a maximum allowed pressure load. Further, the node resource threshold information corresponds to the workload information. For example, if the workload information includes various measurable index data corresponding to the calculation task, the node resource threshold information also includes total resource load amounts corresponding to the various measurable indexes in the cluster node. In another example, the workload information of information of the calculation tasks to be scheduled includes network card traffic, and then during division of the calculation tasks, the set node resource threshold information corresponding to the cluster correspondingly includes the network card traffic. In one embodiment, a sum of values of workload information of calculation tasks divided into the same cluster node with respect to the same measurable index data shall not exceed a total resource load amount corresponding to the measurable index in the cluster node. For example, there are calculation tasks E, F, and G divided into the same cluster node, and if the workload information includes network card traffic, a sum of network card traffic consumed by respective running of the calculation tasks E, F, and G is a, and the total resource load amount of the network card traffic corresponding to the cluster node is b, the network card traffic value a cannot exceed b, so as to ensure feasible and optimized operation of the calculation tasks gathered under the same cluster node by division under the corresponding cluster node. Further, an optimal range (e.g., a no more than 10% drop) may further be set for the node resource threshold information corresponding to the cluster. That is, the total resource load amount of the network card traffic corresponding to the cluster node is b, and then it can be set that an optimal effect is achieved when a sum of the calculation tasks under the cluster node reaches a range of 0.9b−b, excessive resources of the cluster node are not utilized and resource waste is caused when the sum is less than 0.9b, and the cluster node is under excessive pressure when the sum exceeds the total resource load amount of b.

The node resource threshold information may be set by testing pressure of the cluster node and performing sample collection and analysis based on the specific running status of the calculation tasks under the cluster node. Theoretically, when servers corresponding to the cluster nodes have consistent configuration, for example, conditions such as software configuration, hardware configuration, and operating environment of the servers are consistent, the cluster nodes also have the same resource threshold information. In actual applications, different configurations may also be set for different servers used as the cluster nodes based on the needs of cluster resource allocation or the needs of a specific calculation task, so as to differentially set resource threshold information of different nodes in the cluster. In some embodiments, the servers corresponding to all the cluster nodes have the same configuration, so that the nodes in the cluster have consistent node resource threshold information corresponding thereto.

Those skilled in the art should be able to understand that the aforementioned method for setting node resource threshold information, such as a pressure testing method, is merely an example, and other methods for setting node resource threshold information.

In one embodiment, the second device (102) of the apparatus (100) performs a division operation based on workload information corresponding to the calculation tasks, in combination with node resource threshold information corresponding to the cluster until the plurality of calculation tasks are divided into a plurality of task subsets, where each of the task subsets corresponds to one cluster node in the cluster, and the division operation includes: selecting one of the calculation tasks to be divided in the plurality of calculation tasks to serve as a first calculation task; determining one or more candidate task subsets, where the candidate task subset includes the first calculation task and at least one of the other calculation tasks to be divided in the plurality of calculation tasks, and accumulated information of workload information of the calculation tasks in the candidate task subsets satisfies the node resource threshold information; and preferentially determining the task subsets from the one or more candidate task subsets.

In order to reschedule a plurality of calculation tasks previously belonging to different nodes in the cluster to a plurality of task subsets, a division operation may be performed on the plurality of calculation tasks. First, one of the calculation tasks to be divided is selected in the plurality of calculation tasks to be scheduled to serve as a first calculation task, where the selection method may be random or based on a certain rule, for example, a calculation task with increased load corresponding to the workload information may be selected. In one embodiment, the selected first calculation task may be set to correspond to a cluster node 1. Subsequently, one or more calculation tasks matching the first calculation task are selected for the first calculation task in the remaining plurality of calculation tasks to be scheduled. The condition to be satisfied by the matching includes that accumulated information of workload information corresponding to the first calculation task and the one or more calculation tasks matching the first calculation task shall not exceed a maximum amount of corresponding node resource threshold information. In one embodiment, workload information corresponding to each calculation task is set to a value of a certain piece of measurable index data at a definite point in time. For example, the workload information is set to network card traffic information, a point in time T in a time dimension is selected, and a node resource threshold of the cluster node 1 corresponding to the first calculation task A corresponding to network card traffic information is L. In this example, an optimal range of the node resource threshold L may be preferably a no more than 10% drop. At this time, a calculation task matching the first calculation task A is found for the first calculation task A. If network card traffic information of the first calculation task A is L1 at the point in time T, and if a calculation task B is selected for matching with the first calculation task A at this time, the corresponding network card traffic information is L2. Further, if a sum of L1 and L2 already exceeds the node resource threshold L at this time, the calculation task B does not match the first calculation task A and then the calculation task B is abandoned and a new matching calculation task is looked for. Alternatively, if the sum of L1 and L2 is already within the optimal range of the node resource threshold L at this time, it indicates that the calculation task A and the calculation task B satisfy the matching condition and may correspond to one candidate task subset. Alternatively, if the sum of L1 and L2 satisfies the condition of being less than the node resource threshold L but the value thereof is beyond the optimal range of the node resource threshold L at this time, one or more calculation tasks may be further looked for matching with the first calculation task A and the calculation task B in order to fully utilize resources of the cluster node. Further, accumulated information of various workload information, for example, workload information corresponding to various time dimensions of various measurable index data, of the calculation tasks in the determined one or more candidate task subsets needs to satisfy the node resource threshold information corresponding thereto.

Further, in actual operation, the division operation may rely on multiple kinds of measurable index data, and even comprehensive index data consisting of a plurality of pieces of single measurable index data. Meanwhile, there may be a plurality of time dimensions received, there may also be a plurality of specific points in time, and then the final division result also has a variety of possibilities based on different parameter changes. One or more candidate task subsets including the first calculation task and one or more of the other calculation tasks at the same time may be obtained through the division operation. Next, preferential judgment may be further performed based on certain information, for example, data such as a pulse ratio.

In one embodiment, determining the task subsets from the one or more candidate task subsets includes determining task subset-related information of the candidate task subsets and determining the task subsets from the one or more candidate task subsets based on the task subset-related information.

Specifically, when a plurality of candidate task subsets are determined based on the first calculation task through a certain division operation, a further determination is made regarding the plurality of candidate task subsets based on task subset-related information of the task subsets. The task subset-related information includes a pulse ratio of a candidate task subset. For example, one candidate task subset M includes a first calculation task A, a calculation task B, and a calculation task C, the workload information is set to network card traffic information, a time dimension of hour is selected, and a node resource threshold of the cluster node 1 corresponding to the first calculation task A corresponding to network card traffic information is L. An optimal range of the node resource threshold L may be preferably a no more than 10% drop. As a candidate task subset, a sum of data values L1, L2, and L3 corresponding to network card traffic information of the calculation tasks A, B, and C should not exceed the node resource threshold L. At T1, a ratio of a maximum in the corresponding L1, L2, and L3 to an average of L1, L2, and L3 is a pulse value of the candidate task subset M at the point in time T1, when the time dimension is hour, each of the points in time T1, T2, T3 . . . corresponds to one pulse value, and the pulse values corresponding to the points in time form one set, then a ratio of a maximum to a minimum in the set is the pulse ratio. The smaller the pulse ratio, the better the resource utilization effect of the corresponding candidate task subset.

The task subset-related information may further include calculating a difference between a sum of values corresponding to calculation tasks in the same candidate task subset at the same definite point in time of the same measurable index data and node resource threshold information of a cluster node corresponding to the task subset. For example, one candidate task subset N includes a first calculation task A, a calculation task D, and a calculation task E, the workload information is set to network card traffic information, a time dimension of hour is selected, and a node resource threshold of the cluster node 1 corresponding to the first calculation task A corresponding to network card traffic information is L. An optimal range of the node resource threshold L may be preferably a no more than 10% drop. As a candidate task subset, a sum of data values L1, L4, and L5 corresponding to network card traffic information of the calculation tasks A, D, and E should not exceed the node resource threshold L, and a corresponding difference is L−(L1+L4+L6) at this time. The smaller the difference, the better the resource utilization effect of the corresponding candidate task subset.

In some embodiments, a certain kind of task subset-related information may be used for further screening of the candidate task subsets. In one embodiment, multiple kinds of task subset-related information may also be used at the same time for comprehensive comparison, for example, the corresponding pulse ratios and differences are calculated for the candidate task subset M and the candidate task subset N to obtain the optimal choice. Specifically, in actual application, the priority of the pulse ratio may be preferably higher than the priority of the difference. For example, the optimal range of the node resource threshold L is preferably a no more than 10% drop, and meanwhile, if it is additionally specified that a wider preferred range, for example, a range of 80%-95%, of the pulse ratio in the node resource threshold L is preferred, if the pulse ratio corresponding to the candidate task subset M is within the range of 80%-95%, while the candidate task subset N cannot reach this range, the candidate task subset M is preferred regardless of differences of the two task subsets. In one embodiment, the optimal range of 10% of the node resource threshold L and the wider preferred range, for example, a range of 80%-95%, corresponding to the pulse ratio in the node resource threshold L are merely examples and can be flexibly arranged based on actual service requirements.

In one embodiment, task subset-related information including a pulse ratio of a candidate task subset, the task subset-related information that may further include calculating a difference between a sum of values corresponding to calculation tasks in the same candidate task subset at the same definite point in time of the same measurable index data, and node resource threshold information of a cluster node corresponding to the task subset are merely examples, and other task subset-related information may be utilized.

In one embodiment, the accumulated information of workload information of the calculation tasks in the candidate task subsets in the apparatus (100) satisfying the node resource threshold information includes the accumulated information of the workload information of the calculation tasks in the candidate task subsets respectively satisfying the node resource threshold information in terms of dimension.

Specifically, to enable workload information of the calculation tasks to comprehensively and objectively reflect resource overhead needs of the calculation tasks, a division operation of the plurality of calculation tasks is based on multiple dimensions of measurable index data. For example, the measurable index data may be simultaneously and respectively sourced from the following plurality of attribute indexes related to the calculation tasks: a CPU usage rate, a memory usage rate, network usage, memory usage, and network card traffic. The measurable index data is not only a plurality of pieces of single and specific measurable index data but also several pieces of comprehensive measurable index data formed by combining a plurality of indexes. For example, a piece of comprehensive index data is generated by calculating single measurable index data, a CPU usage rate, a memory usage rate, and network usage, based on a certain combination, for example, a certain weight is separately set for the CPU usage rate, the memory usage rate, and a network usage parameter based on the actual situation so as to obtain required comprehensive measurable index data. The measurable index data corresponding to the workload information is diversified to provide the most comprehensive basic data for dividing of the calculation tasks, so that the most ideal division method can be found as anticipated according to purposes of the calculation tasks, thus making cluster resource allocation and utilization most reasonable and conform to actual service requirements in a better way. Meanwhile, multiple time dimensions are used as a basis, and recorded workload information data may be recorded based on any required unit of time such as year, month, day, hour, minute, and second. In one embodiment, data in one or more suitable dimensions may be selected for utilization based on the specific division purpose of a plurality of calculation tasks to be scheduled.

In another embodiment, the second device (102) of the apparatus (100) determines task overhead information of a plurality of historical calculation tasks based on task computing log information of the cluster; and determines workload information of the calculation tasks based on the task overhead information of the plurality of historical calculation tasks.

In some embodiments, since the workload information of the calculation tasks to be scheduled changes dynamically, the workload information of the calculation tasks to be scheduled that is obtained at anytime is already historical data in practice. However, at the same time, for the calculation task, for example, an Internet cloud calculation task, the computing execution of the same type of calculation tasks, especially a series of calculation tasks having similar or identical parameter conditions, consumes similar cluster resources, so a specific historical calculation task has reference value for later calculation tasks matching the historical calculation task. Further, if a reasonable matching method is used, a desirable matchable model historical calculation task can be found for a calculation task to be scheduled currently, task overheads possibly required by the calculation task to be scheduled can be inferred based on task overhead information of the historical calculation task, for example, pressure data corresponding to different measurable indexes in different time dimensions, and workload information required for dividing the plurality of calculation tasks can be obtained accordingly.

In one embodiment, determining task overhead information of a plurality of historical calculation tasks based on task computing log information of the cluster; and determining workload information of the calculation tasks based on the task overhead information of the plurality of historical calculation tasks are merely examples, and other steps of determining workload information of the calculation tasks.

In one embodiment, the determining workload information of the calculation tasks based on the task overhead information of the plurality of historical calculation tasks includes: screening out a preferred historical calculation task matching the calculation tasks from the plurality of historical calculation tasks based on task-related information of the calculation tasks; and determining the workload information of the calculation tasks based on task overhead information of the preferred historical calculation task.

Specifically, the task-related information of the calculation task includes various related information capable of describing and positioning multiple aspects including the execution condition and execution status of one calculation task, for example, various parameters involved while performing the calculation task, for example, requirements for software and hardware of the server. In one embodiment, the historical calculation task corresponding to the calculation task may be the same dynamic calculation task as the calculation task, except that corresponding data changes regularly due to change in time; the corresponding historical calculation task and the calculation task may also be two completely independent dynamic calculation tasks, but have high similarity and thus are suitable for matching. Additionally, in the process of looking for a historical calculation task matching the calculation task, there may be a plurality of matchable historical calculation tasks having certain matching degrees; at this time, the most preferred historical calculation task may be screened out based on the type of the emphasized parameter based on requirements for precision.

In one embodiment, determining workload information of the calculation tasks based on the task overhead information of the plurality of historical calculation tasks includes determining task overhead information corresponding to each calculation task cluster by clustering the plurality of historical calculation tasks based on task-related information of the plurality of historical calculation tasks; determining a preferred calculation task cluster matching the calculation tasks based on task-related information of the calculation tasks; and determining the workload information of the calculation tasks based on task overhead information of the preferred calculation task cluster.

Specifically, by selecting a preferred historical calculation task matching the calculation tasks based on the numerous historical calculation tasks, the workload information of the calculation tasks can be objectively and accurately determined by using task overhead information of the preferred historical calculation task. In addition, the plurality of historical calculation tasks may be clustered firstly based on determined task-related information. In one embodiment, the similarity using a specific one or more measures as the standard in the clustering is minimized between unified clusters and is maximized between different clusters. The plurality of historical calculation tasks are aggregated into a plurality of categories through a clustering algorithm. On one hand, information to be found and compared can be greatly reduced to several historical calculation task clusters, and on the other hand, task overhead information corresponding to the historical calculation task clusters obtained by clustering is a statistical analysis result and has greater universality and wide applicability. Matching data can be found for the calculation tasks based on the clustering standard corresponding to the preferred calculation task cluster, and it is more efficient and feasible to determine the workload information of the calculation tasks by using task overhead information corresponding to the matching preferred calculation task cluster.

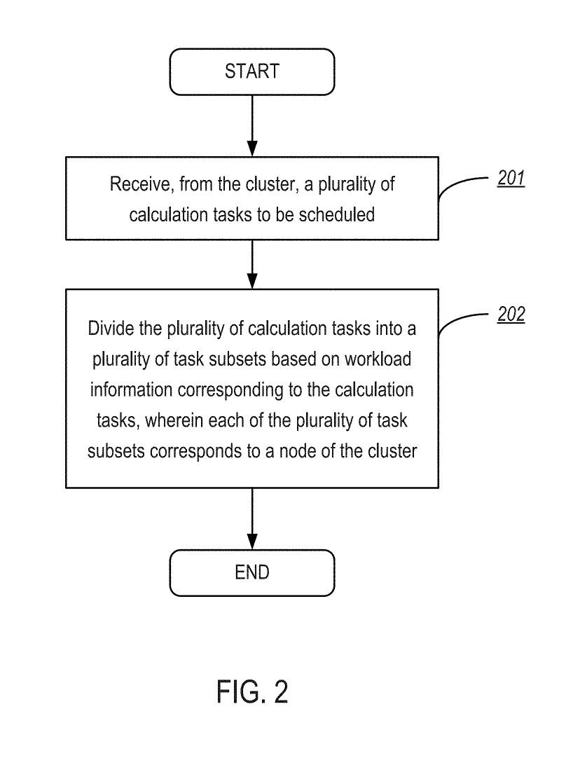

FIG. 2 is a flow diagram of a method for scheduling calculation tasks in a cluster according to some embodiments of the disclosure.

In step 201, the apparatus (100) receives, from a cluster, a plurality of calculation tasks to be scheduled. In step 202, the apparatus (100) divides the plurality of calculation tasks into a plurality of task subsets based on workload information corresponding to the calculation tasks, where each of the plurality of task subsets corresponds to a node of the cluster.

Specifically, in step 201, the apparatus (100) receives, from the cluster, a plurality of calculation tasks to be scheduled. In some embodiments, a cluster includes a plurality of servers configured to perform cloud computing tasks via the Internet. Each of the servers is a cluster node providing a service such as cloud computing to a user. Each of the servers has several calculation tasks for execution thereon. The calculation tasks include processes, threads, and the like running on a cluster node. In some embodiments, the method reschedules and divides a plurality of calculation tasks to a plurality of cluster nodes in a cluster to optimize cluster resource allocation, so it is necessary to determine a plurality of calculation tasks awaiting scheduling. In these embodiments, the larger the resource pool, the greater the number of calculation tasks to be scheduled and the higher the system matching degree of the scheduling. Furthermore, the higher the scheduling precision the more significant the optimization of cluster resource allocation.

In addition, each of the calculation tasks has a corresponding backup calculation task in the cluster (e.g., a cloud resource system) so that data corresponding to the calculation task can be saved, and further, consistency of data between the calculation task and the corresponding backup calculation task is ensured through a synchronization mechanism. By performing backup for disaster recovery on a calculation task, losses caused by emergencies such as damage or loss of data can be avoided.

In alternative embodiments, the plurality of calculation tasks to be scheduled in the cluster received in step 201 may also be deployed on a third-party apparatus other than the apparatus (100). That is, a plurality of calculation tasks to be scheduled are collected from the third-party apparatus, and then the apparatus (100) performs corresponding operations such as information processing and task scheduling generation and execution.

In step 202, the apparatus (100) divides the plurality of calculation tasks into a plurality of task subsets based on workload information corresponding to the calculation tasks, where each of the task subsets correspond to one cluster node in the cluster. In one embodiment, if optimal division is to be performed on a plurality of different calculation tasks to maximize utilization of cluster resources, it is foremost required to obtain workload information of the plurality of calculation tasks waiting for scheduling. The workload information includes various measurable index data corresponding to the calculation task, including, but not limited to, attribute indexes related to the calculation task such as a CPU usage rate, a memory usage rate, network usage, memory usage, and network card traffic. The index data can visually reflect the use and consumption needs of the calculation task for a specific one or more related cluster resources, for example, a corresponding CPU usage rate or memory usage rate required by running of one process task. The more a certain type of cluster resources is consumed by the calculation task, the greater the pressure load is applied to the cluster node corresponding to the calculation task. In addition, the workload information may also be a piece of comprehensive measurable index data formed by combining a plurality of pieces of single and specific measurable index data. For example, a piece of comprehensive index data is generated by calculating single measurable index data, a CPU usage rate, a memory usage rate, and network usage, based on a certain combination, for example, a certain weight is separately set for the CPU usage rate, the memory usage rate, and a network usage parameter based on the actual situation so as to obtain required comprehensive measurable index data.

For example, specific values of all the plurality of calculation tasks to be scheduled based on the same measurable index in the same time period or at the same point in time are analyzed and compared, and a plurality of calculation tasks satisfying an optimal division condition can be divided into the same task subset based on a certain division operation. For example, if there are calculation tasks A, B, C, and D to be scheduled, which respectively belong to cluster nodes 1, 2, 3, and 4; three calculation tasks A, B, and C are selected and divided into one task subset and correspond to the cluster node 1 by analyzing respective workload information of the calculation tasks A, B, C, and D and based on a specific division operation, and the generation of the new calculation task combination optimizes cluster resource utilization. The service capability of cloud computing provided by cluster resources shows the characteristics of dynamic distribution and real-time change, and workload information used as the source of computing data corresponding to the division operation in this solution can well reflect such dynamic data change. For example, the workload information may be accurate to specific value information corresponding to a definite measurable index in a definite time period or at a definite point in time.

Those skilled in the art should be able to understand that step 201 and step 202 may be implemented on the same apparatus. Further, in actual application, operations corresponding to step 201 and step 202 may also be deployed on different apparatuses for implementation, which should also fall into the scope of the disclosure and be incorporated herein by reference.

In some embodiments, each of a plurality of calculation tasks to be scheduled in a cluster is divided into a task subset corresponding to a certain cluster node based on workload information corresponding to the calculation tasks, so that an optimal division combination is found for the plurality of calculation tasks to be scheduled in the cluster, so as to utilize resources of the entire cluster to a maximum extent and realize a more reasonable system resource scheduling policy.

In one embodiment, the method further includes step 203 (not shown), and in step 203, the apparatus (100) allocates the task subset to the corresponding cluster node and performs, in the cluster node, the calculation tasks in the task subset.

Specifically, by collecting resource usage of the calculation tasks and then performing task scheduling through a computing engine, system resources corresponding to a certain calculation task have been ready when the Internet user requests the calculation task, and the calculation task can directly use the system resources after scheduling. The plurality of divided calculation tasks are allocated to a corresponding cluster node and share cluster resources through the cluster node. At this time, resources to be consumed while redividing calculation tasks under the cluster node (e.g., resources such as network card traffic, CPU, and memory required to be used when the corresponding Internet user requests a certain cloud calculation task) all need to be allocated from a total amount of resources owned by a cluster node corresponding to the cloud calculation task. Therefore, performing the calculation task is implemented based on the cluster node. In one embodiment, in a cloud calculation task, the cluster uses a control system to analyze and collect related data of the cluster nodes and calculation tasks under the cluster nodes and stores the related information in the control system to serve as basic data for developing an information scheduling policy.

Those skilled in the art should be able to understand that step 201, step 202, and step 203 may be implemented on the same apparatus. Further, in actual application, operations corresponding to step 201, step 202, and step 203 may also be deployed on different apparatuses for implementation, which should also fall into the scope of the disclosure and be incorporated herein by reference.

In one embodiment, in step 202, the apparatus (100) divides the plurality of calculation tasks into a plurality of task subsets based on workload information corresponding to the calculation tasks, in combination with node resource threshold information corresponding to the cluster, where each of the task subsets corresponds to one cluster node in the cluster.

Specifically, a plurality of calculation tasks to be scheduled in a cluster are divided into the same task subset, each task subset corresponds to one cluster node in the cluster, the division operation requires obtaining of workload information of the calculation tasks to be scheduled and meanwhile requires the setting of node resource threshold information corresponding to the cluster. In some embodiments, the node resource threshold information includes cluster nodes with a maximum allowed pressure load. Further, the node resource threshold information corresponds to the workload information, for example, if the workload information includes various measurable index data corresponding to the calculation task, the node resource threshold information also includes total resource load amounts corresponding to the various measurable indexes in the cluster node. For example, if the workload information of information of the calculation tasks to be scheduled includes network card traffic, then during a division operation of the calculation tasks, the set node resource threshold information corresponding to the cluster correspondingly includes the network card traffic. In one embodiment, a sum of values of workload information of calculation tasks divided into the same cluster node with respect to the same measurable index data shall not exceed a total resource load amount corresponding to the measurable index in the cluster node. For example, there are calculation tasks E, F, and G divided into the same cluster node, and if the workload information includes network card traffic, a sum of network card traffic consumed by respective running of the calculation tasks E, F, and G is a, and the total resource load amount of the network card traffic corresponding to the cluster node is b, the network card traffic value a cannot exceed b, so as to ensure feasible and optimized operation of the calculation tasks gathered under the same cluster node by dividing under the corresponding cluster node. Further, an optimal range (for example, a no more than 10% drop) may further be set for the node resource threshold information corresponding to the cluster, that is, the total resource load amount of the network card traffic corresponding to the cluster node is b, and then it can be set that an optimal effect is achieved when a sum of the calculation tasks under the cluster node reaches a range of 0.9b−b, excessive resources of the cluster node are not utilized and resource waste is caused when the sum is less than 0.9b, and the cluster node is under excessive pressure when the sum exceeds the total resource load amount of b.

In one embodiment, the node resource threshold information may be set by testing pressure of the cluster node and performing sample collection and analysis based on the specific running status of the calculation tasks under the cluster node. Theoretically, when servers corresponding to the cluster nodes have consistent configuration (e.g., conditions such as software configuration, hardware configuration, and operating environment of the servers are consistent) the cluster nodes also have the same resource threshold information. In actual application, different configurations may also be set for different servers used as the cluster nodes based on the needs of cluster resource allocation or the needs of a specific calculation task, so as to differentially set resource threshold information of different nodes in the cluster. In one embodiment, the servers corresponding to all the cluster nodes have the same configuration, so that the nodes in the cluster have consistent node resource threshold information corresponding thereto.

Those skilled in the art should be able to understand that the aforementioned method for setting node resource threshold information, such as a pressure testing method, is merely an example, and other methods for setting node resource threshold information may be utilized.

In step 202, the apparatus (100) performs a division operation based on workload information corresponding to the calculation tasks, in combination with node resource threshold information corresponding to the cluster until the plurality of calculation tasks are divided into a plurality of task subsets, where each of the task subsets corresponds to one cluster node in the cluster, and the division operation includes: selecting one of the calculation tasks to be divided in the plurality of calculation tasks to serve as a first calculation task; determining one or more candidate task subsets, where the candidate task subset includes the first calculation task and at least one of the other calculation tasks to be divided in the plurality of calculation tasks, and accumulated information of workload information of the calculation tasks in the candidate task subsets satisfies the node resource threshold information; and preferentially determining the task subsets from the one or more candidate task subsets.

Specifically, in order to reschedule a plurality of calculation tasks previously belonging to different nodes in the cluster to a plurality of task subsets, a division operation may be performed on the plurality of calculation tasks. First, one of the calculation tasks to be divided is selected in the plurality of calculation tasks to be scheduled to serve as a first calculation task, where the selection method may be random or based on a certain rule, for example, a calculation task with increased load corresponding to the workload information is preferentially selected. For example, the selected first calculation task may be set to correspond to a cluster node 1. Subsequently, one or more calculation tasks matching the first calculation task are selected for the first calculation task in the remaining plurality of calculation tasks to be scheduled. The condition to be satisfied by the matching includes that accumulated information of workload information corresponding to the first calculation task and the one or more calculation tasks matching the first calculation task shall not exceed a maximum amount of corresponding node resource threshold information. In one embodiment, workload information corresponding to each calculation task is set to a value of a certain piece of measurable index data at a definite point in time. For example, the workload information is set to network card traffic information, a point in time T in a time dimension is selected, and a node resource threshold of the cluster node 1 corresponding to the first calculation task A corresponding to network card traffic information is L. An optimal range of the node resource threshold L may be preferably a no more than 10% drop. At this time, a calculation task matching the first calculation task A is found for the first calculation task A. If network card traffic information of the first calculation task A is L1 at the point in time T, if a calculation task B is selected for matching with the first calculation task A at this time, the corresponding network card traffic information is L2, and if a sum of L1 and L2 already exceeds the node resource threshold L at this time, the calculation task B does not match the first calculation task A and the calculation task B is ignored and a new matching calculation task is looked for. If the sum of L1 and L2 is already within the optimal range of the node resource threshold L at this time, it indicates that the calculation task A and the calculation task B satisfy the matching condition and may correspond to one candidate task subset. Alternatively, if the sum of L1 and L2 satisfies the condition of being less than the node resource threshold L but the value thereof is beyond the optimal range of the node resource threshold L at this time, one or more calculation tasks may be further looked for matching with the first calculation task A and the calculation task B in order to fully utilize resources of the cluster node. Further, accumulated information of various workload information, for example, workload information corresponding to various time dimensions of various measurable index data, of the calculation tasks in the determined one or more candidate task subsets needs to satisfy the node resource threshold information corresponding thereto.

Further, in some embodiments, the division operation may rely on multiple kinds of measurable index data, and even comprehensive index data consisting of a plurality of pieces of single measurable index data; meanwhile, there may be a plurality of time dimensions received, there may also be a plurality of specific points in time, and furthermore the final division result also has a variety of possibilities based on different parameter changes. One or more candidate task subsets including the first calculation task and one or more of the other calculation tasks at the same time may be obtained through the division operation. Next, preferential judgment may be further performed based on certain information, for example, data such as a pulse ratio.

In one embodiment, the preferentially determining the task subsets from the one or more candidate task subsets includes: determining task subset-related information of the candidate task subsets; and preferentially determining the task subsets from the one or more candidate task subsets based on the task subset-related information.

Specifically, when a plurality of candidate task subsets are determined based on the first calculation task through a certain division operation, it is required to make further determination on the plurality of candidate task subsets based on task subset-related information of the task subsets. In one embodiment, the task subset-related information includes a pulse ratio of a candidate task subset. For example, one candidate task subset M includes a first calculation task A, a calculation task B, and a calculation task C, the workload information is set to network card traffic information, a time dimension of hour is selected, and a node resource threshold of the cluster node 1 corresponding to the first calculation task A corresponding to network card traffic information is L. In one embodiment, an optimal range of the node resource threshold L may be preferably a no more than 10% drop. As a candidate task subset, a sum of data values L1, L2, and L3 corresponding to network card traffic information of the calculation tasks A, B, and C should not exceed the node resource threshold L. At T1, a ratio of a maximum in the corresponding L1, L2, and L3 to an average of L1, L2, and L3 is a pulse value of the candidate task subset M at the point in time T1, when the time dimension is hour, each of the points in time T1, T2, T3 . . . corresponds to one pulse value, and the pulse values corresponding to the points in time form one set, then a ratio of a maximum to a minimum in the set is the pulse ratio. The smaller the pulse ratio, the better the resource utilization effect of the corresponding candidate task subset.

In one embodiment, the task subset-related information may further include: calculating a difference between a sum of values corresponding to calculation tasks in the same candidate task subset at the same definite point in time of the same measurable index data and node resource threshold information of a cluster node corresponding to the task subset. For example, one candidate task subset N includes a first calculation task A, a calculation task D, and a calculation task E, the workload information is set to network card traffic information, a time dimension of hour is selected, and a node resource threshold of the cluster node 1 corresponding to the first calculation task A corresponding to network card traffic information is L. In one embodiment, an optimal range of the node resource threshold L may be preferably a no more than 10% drop. As a candidate task subset, a sum of data values L1, L4, and L5 corresponding to network card traffic information of the calculation tasks A, D, and E should not exceed the node resource threshold L, and a corresponding difference is L−(L1+L4+L5) at this time. The smaller the difference, the better the resource utilization effect of the corresponding candidate task subset.

In one embodiment, a certain kind of task subset-related information may be used for further screening of the candidate task subsets. In some embodiments, multiple kinds of task subset-related information may also be used at the same time for comprehensive comparison, for example, the corresponding pulse ratios and differences are calculated for the candidate task subset M and the candidate task subset N to obtain an optimal choice. Specifically, in some embodiments, the priority of the pulse ratio may be higher than the priority of the difference, for example, the optimal range of the node resource threshold L is preferably a no more than 10% drop, and meanwhile, if it is additionally specified that a wider preferred range, for example, a range of 80%-95%, of the pulse ratio in the node resource threshold L is preferred, if the pulse ratio corresponding to the candidate task subset M is within the range of 80%-95%, while the candidate task subset N cannot reach this range, the candidate task subset M is preferred regardless of differences of the two task subsets. In one embodiment, the optimal range of 10% of the node resource threshold L and the wider preferred range, for example, a range of 80%-95%, corresponding to the pulse ratio in the node resource threshold L are merely examples and can be flexibly arranged based on actual service requirements.

In one embodiment, the aforementioned task subset-related information including a pulse ratio of a candidate task subset, and the task subset-related information that may further include: calculating a difference between a sum of values corresponding to calculation tasks in the same candidate task subset at the same definite point in time of the same measurable index data and node resource threshold information of a cluster node corresponding to the task subset are merely examples, and other task subset-related information.

In one embodiment, the accumulated information of workload information of the calculation tasks in the candidate task subsets in the apparatus (100) satisfying the node resource threshold information includes: the accumulated information of the workload information of the calculation tasks in the candidate task subsets respectively satisfying the node resource threshold information in terms of dimension.

Specifically, to enable workload information of the calculation tasks to comprehensively and objectively reflect resource overhead needs of the calculation tasks, a division operation of the plurality of calculation tasks is based on multiple dimensions of measurable index data. For example, the measurable index data may be simultaneously and respectively sourced from the following plurality of attribute indexes related to the calculation tasks such as a CPU usage rate, a memory usage rate, network usage, memory usage, and network card traffic. The measurable index data is not only a plurality of pieces of single and specific measurable index data but also several pieces of comprehensive measurable index data formed by combining a plurality of indexes. For example, a piece of comprehensive index data is generated by calculating single measurable index data, a CPU usage rate, a memory usage rate, and network usage, based on a certain combination, for example, a certain weight is separately set for the CPU usage rate, the memory usage rate, and a network usage parameter based on the actual situation so as to obtain required comprehensive measurable index data. The measurable index data corresponding to the workload information is diversified to provide the most comprehensive basic data for dividing of the calculation tasks, so that the most ideal division method can be found as anticipated based on purposes of the calculation tasks, thus making cluster resource allocation and utilization most reasonable and conform to actual service requirements in a better way. Meanwhile, multiple time dimensions are used as a basis, and recorded workload information data may be recorded based on any required unit of time such as year, month, day, hour, minute, and second. In one embodiment, data in one or more suitable dimensions may be selected for utilization based on the specific division purpose of a plurality of calculation tasks to be scheduled.

In another embodiment, in step 202, the apparatus (100) determines task overhead information of a plurality of historical calculation tasks based on task computing log information of the cluster; and determines workload information of the calculation tasks based on the task overhead information of the plurality of historical calculation tasks.

Specifically, since the workload information of the calculation tasks to be scheduled changes dynamically, the workload information of the calculation tasks to be scheduled that is obtained at any time is already historical data in practice. However, at the same time, for the calculation task, for example, an Internet cloud calculation task, the computing execution of the same type of calculation tasks, especially a series of calculation tasks having similar or identical parameter conditions, consumes similar cluster resources, so a specific historical calculation task has reference value for later calculation tasks matching the historical calculation task. Further, if a reasonable matching method is used, a desirable matchable model historical calculation task can be found for a calculation task to be scheduled currently, task overheads possibly required by the calculation task to be scheduled can be inferred based on task overhead information of the historical calculation task, for example, pressure data corresponding to different measurable indexes in different time dimensions, and workload information required for dividing the plurality of calculation tasks can be obtained accordingly.

Those skilled in the art should be able to understand that the aforementioned determining task overhead information of a plurality of historical calculation tasks based on task computing log information of the cluster; and determining workload information of the calculation tasks based on the task overhead information of the plurality of historical calculation tasks is merely an example, and other determining of workload information of the calculation tasks.

In one embodiment, the determining workload information of the calculation tasks based on the task overhead information of the plurality of historical calculation tasks includes: screening out a preferred historical calculation task matching the calculation tasks from the plurality of historical calculation tasks based on task-related information of the calculation tasks; and determining the workload information of the calculation tasks based on task overhead information of the preferred historical calculation task.

Specifically, the task-related information of the calculation task includes various related information capable of describing and positioning multiple aspects including the execution condition and execution status of one calculation task, for example, various parameters involved while performing the calculation task, for example, requirements for software and hardware of the server. In one embodiment, the historical calculation task corresponding to the calculation task may be the same dynamic calculation task as the calculation task, except that corresponding data changes regularly due to change in time; the corresponding historical calculation task and the calculation task may also be two completely independent dynamic calculation tasks, but have high similarity and thus are suitable for matching. Additionally, in the process of looking for a historical calculation task matching the calculation task, there may be a plurality of matchable historical calculation tasks having certain matching degrees; at this time, the most preferred historical calculation task may be screened out based on the type of the emphasized parameter based on requirements for precision.

In one embodiment, the determining workload information of the calculation tasks based on the task overhead information of the plurality of historical calculation tasks includes: determining task overhead information corresponding to each calculation task cluster by clustering the plurality of historical calculation tasks based on task-related information of the plurality of historical calculation tasks; determining a preferred calculation task cluster matching the calculation tasks based on task-related information of the calculation tasks; and determining the workload information of the calculation tasks based on task overhead information of the preferred calculation task cluster.

Specifically, by selecting a preferred historical calculation task matching the calculation tasks based on the numerous historical calculation tasks, the workload information of the calculation tasks can be objectively and accurately determined by using task overhead information of the preferred historical calculation task. In addition, the plurality of historical calculation tasks may be clustered first based on determined task-related information. In one embodiment, the similarity using a specific one or more measures as the standard in the clustering is minimized between unified clusters and is maximized between different clusters. The plurality of historical calculation tasks are aggregated into a plurality of categories through a clustering algorithm. On one hand, information to be found and compared can be greatly reduced to several historical calculation task clusters, and on the other hand, task overhead information corresponding to the historical calculation task clusters obtained by clustering is a statistical analysis result and has greater universality and wide applicability. Matching data can be found for the calculation tasks based on the clustering standard corresponding to the preferred calculation task cluster, and it is more efficient and feasible to determine the workload information of the calculation tasks by using task overhead information corresponding to the matching preferred calculation task cluster.

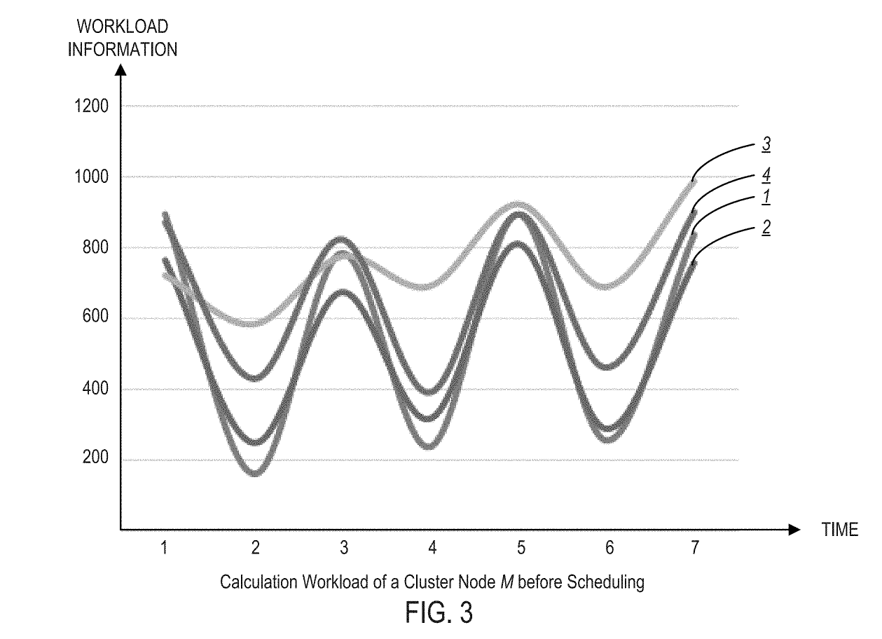

FIGS. 3 through FIG. 6 are diagrams of a calculation workload where, based on respective calculation tasks to be scheduled of two nodes M and N in the cluster, calculation tasks under the two cluster nodes are redivided after the scheduling method of the disclosure is performed, thereby optimizing cluster resource allocation.

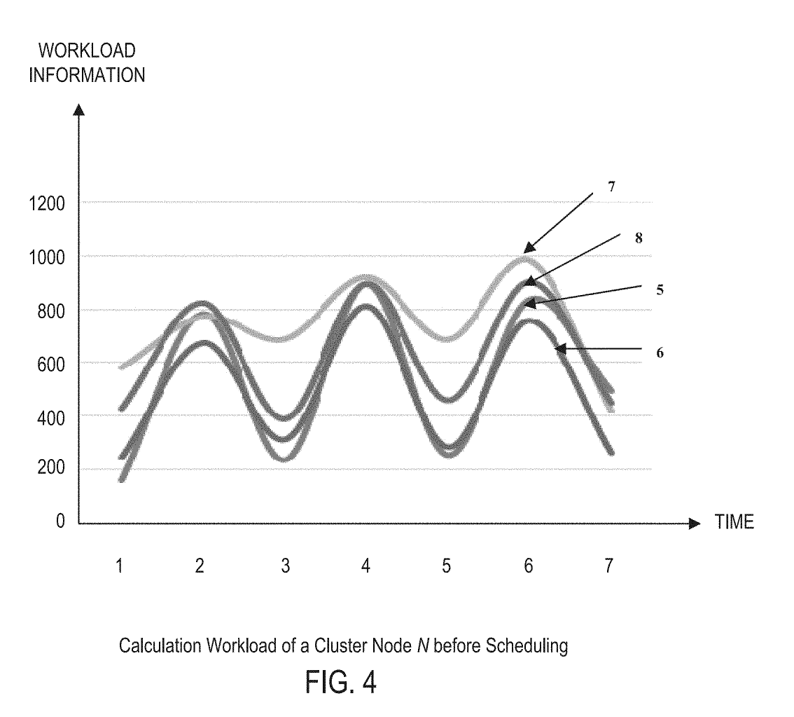

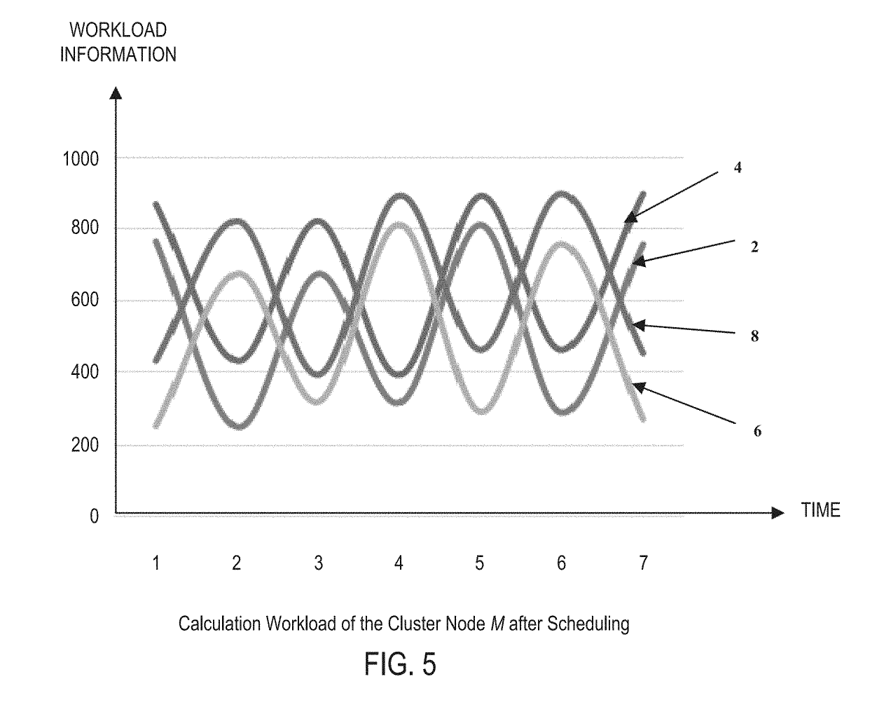

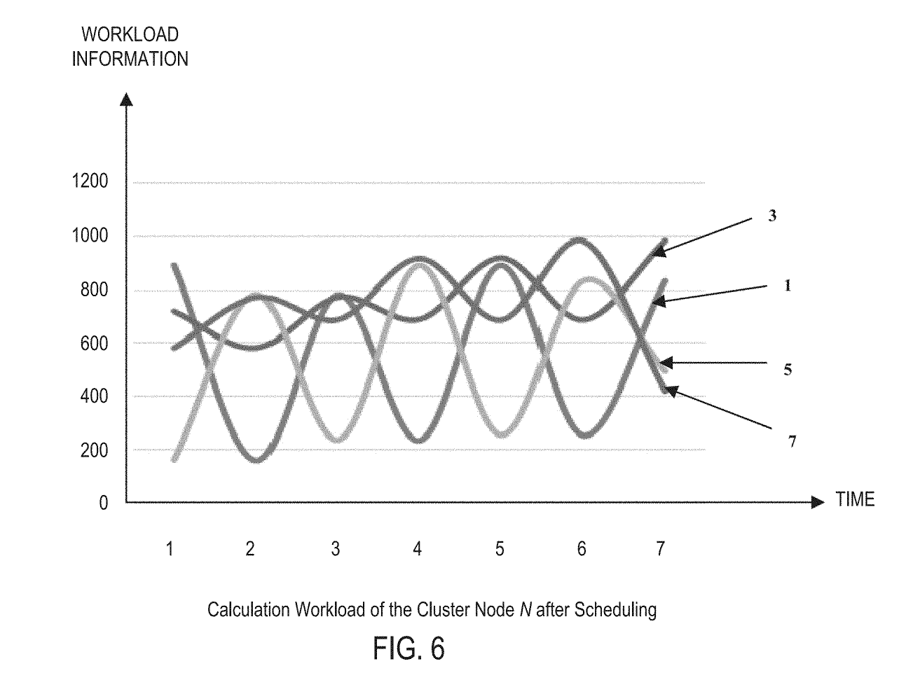

FIG. 3 is a diagram of a calculation workload of a cluster node M before scheduling according to some embodiments of the disclosure. FIG. 4 is a diagram of a calculation workload of a cluster node N before scheduling according to some embodiments of the disclosure. FIG. 5 is a diagram of a calculation workload of the cluster node M after scheduling according to some embodiments of the disclosure. FIG. 6 is a diagram of a calculation workload of the cluster node N after scheduling according to some embodiments of the disclosure.

FIG. 3 shows the workload of calculation tasks 1, 2, 3, and 4 under the cluster node M before a division operation is performed, and FIG. 4 shows the workload of calculation tasks 6, 7, 8, and 9 under the cluster node N before a division operation is performed. In some embodiments, any dimension such as year, month, day, and hour may be selected as the time dimension. The workload information includes various measurable index data corresponding to the calculation task, including, but not limited to, attribute indexes related to the calculation task such as a CPU usage rate, a memory usage rate, network usage, memory usage, and network card traffic. The workload information may also be a piece of comprehensive measurable index data formed by combining a plurality of pieces of single and specific measurable index data. In the illustrated embodiment, the curves in FIG. 3 and FIG. 4 represent the pressure load status of the corresponding calculation task over one week. FIG. 3 illustrates that the corresponding four calculation tasks are all in service valley periods on days 2, 4, and 6 of the week, thus the corresponding pressure load is relatively small. Conversely, the same four calculation tasks are all in service peak periods on days 1, 3, 5 and 7 of the week, thus the corresponding pressure load is relatively large on those days.

FIG. 4 shows that the corresponding four calculation tasks 5, 6, 7, and 8 are all in service peak periods on days 2, 4, and 6 of the week, and the corresponding pressure load is relatively large on these days. Conversely, the corresponding four calculation tasks are all in service valley periods on days 1, 3, 5 and 7 days of the week, and the corresponding pressure load is relatively small on these days.

Calculation tasks 1, 2, 3, and 4 under the cluster node M and calculation tasks 6, 7, 8, and 9 under the cluster node N are used as calculation tasks to be scheduled and a division operation of this method is performed to obtain two optimized task subsets, namely, a corresponding task subset consisting of the calculation tasks 2, 4, 6, and 8 after scheduling of the cluster node M shown in FIG. 5 and a corresponding task subset consisting of the calculation tasks 1, 3, 5, and 7 after scheduling of the cluster node N shown in FIG. 6.

Cluster resources of the cluster nodes M and N are well balanced and complemented at certain points in time. For example, the multiple points in time of one week in the figures by optimized division, thus alleviating the problem of insufficient resource allocation or resource waste caused by excessively large pressure on cluster nodes at some points in time and excessively small pressure at other points in time. Through the division operation of this solution, the specific optimization effect of the division operation is embodied in FIG. 5, where calculation tasks 2 and 4 after scheduling have relatively small pressure load on days 2, 4, and 6 of the week and relatively large pressure load on days 1, 3, 5, and 7 of the week, while the calculation tasks 6 and 8 divided into the cluster node M have relatively large pressure load on days 2, 4, and 6 of the week and relatively small pressure load on the days 1, 3, 5, and 7 of the week. Similarly, in FIG. 6, the calculation tasks 5 and 7 have relatively large pressure load on days 2, 4, and 6 of the week and relatively small pressure load on the days 1, 3, 5, and 7 of the week, while the calculation tasks 1 and 3 divided into the cluster node N have relatively small pressure load on the days 2, 4, and 6 of the week and relatively large pressure load on the days 1, 3, 5, and 7 of the week. Compared with the pressure load status of the cluster nodes M and N before scheduling, an accumulated value of pressure load of calculation tasks under one cluster node is maintained below the node threshold information after scheduling, and a resource utilization optimization result is achieved based on a peak-valley balance of the pressure load of the calculation tasks.

Further, new task subsets are obtained based on rescheduling and dividing of the plurality of calculation tasks, and workload information in a time dimension corresponding to calculation tasks in the task subsets is stored as basic data in a control system corresponding to the cluster to serve as a historical calculation task, thereby providing reference information data for later target calculation task scheduling.

To those skilled in the art, it is apparent that the disclosure is not limited to the details of the aforementioned exemplary embodiments, and the disclosure can be implemented in other specific forms without departing from the spirit or basic features of the disclosure. Therefore, in any way, the embodiments should be regarded as exemplary and non-restrictive; the scope of the disclosure is defined by the appended claims, instead of the above description, and therefore it is intended that the disclosure cover all variations falling into the meaning and scope of equivalent elements of the claims. No reference signs in the claims should be regarded as limiting the involved claims. Additionally, it is apparent that the term “include/comprise” does not exclude other units or steps, and singularity does not exclude plurality. A plurality of units or devices stated in a device claim may also be implemented by one unit or device through software or hardware. Terms such as first and second are used to indicate names, but do not indicate any particular sequence.

1. A method comprising:
receiving, from a cluster, a plurality of calculation tasks to be scheduled; and
dividing the plurality of calculation tasks into a plurality of task subsets based on workload information corresponding to the plurality of calculation tasks, wherein each of the plurality of task subsets is assigned to a node of the cluster.

2. The method of claim 1, further comprising:
allocating a sub cluster of tasks to a corresponding assigned node of the cluster; and
performing, in the corresponding assigned node of the cluster, the calculation tasks in the sub cluster of tasks.

3. The method of claim 1, wherein dividing the plurality of calculation tasks into a plurality of task subsets based on workload information corresponding to the plurality of calculation tasks, wherein each of the plurality of task subsets is assigned to a node of the cluster comprises:
dividing the plurality of calculation tasks into a plurality of task subsets based on workload information corresponding to the plurality of calculation tasks and node resource threshold information corresponding to the cluster, wherein each of the plurality of task subsets is assigned to a node of the cluster.

4. The method of claim 3, wherein dividing the plurality of calculation tasks into a plurality of task subsets based on workload information corresponding to the plurality of calculation tasks, wherein each of the plurality of task subsets is assigned to a node of the cluster comprises:
performing a dividing operation based on workload information corresponding to the plurality of calculation tasks and node resource threshold information corresponding to the cluster until the plurality of calculation tasks are divided into a plurality of task subsets, wherein each of the plurality of task subsets is assigned to a node of the cluster, wherein the dividing operation comprises:
selecting one of the calculation tasks to be divided in the plurality of calculation tasks to serve as a first calculation task;
determining one or more candidate task subsets, wherein the candidate task subsets comprise the first calculation task and at least one of the other calculation tasks to be divided in the plurality of calculation tasks, and the accumulated information of workload information of each of the calculation tasks in the candidate task subsets satisfies the node resource threshold information; and
determining the task subset from the one or more candidate task subsets.

5. The method of claim 4, wherein determining the task subset from the one or more candidate task subsets comprises:
determining task subset-related information of the candidate task subsets; and
determining the task subset from the one or more candidate task subsets based on the task subset-related information.

6. The method of claim 4, wherein the accumulated information of workload information of each of the calculation tasks in the candidate task subsets satisfies the node resource threshold information comprises: the accumulated information of the workload information of the calculation tasks in the candidate task subsets respectively satisfying the node resource threshold information in terms of dimension.

7. The method of claim 1, wherein dividing the plurality of calculation tasks into a plurality of task subsets based on workload information corresponding to the plurality of calculation tasks, wherein each of the plurality of task subsets is assigned to a node of the cluster further comprises:
determining task overhead information of a plurality of historical calculation tasks based on task computing log information of the cluster; and
determining workload information of the calculation tasks based on the task overhead information of the plurality of historical calculation tasks.

8. The method of claim 7, wherein determining workload information of the calculation tasks based on the task overhead information of the plurality of historical calculation tasks comprises:
screening out a historical calculation task matching the calculation tasks from the plurality of historical calculation tasks based on task-related information of the calculation tasks; and
determining the workload information of the calculation tasks based on task overhead information of the historical calculation task.

9. The method of claim 7, wherein determining workload information of the calculation tasks based on the task overhead information of the plurality of historical calculation tasks comprises:
determining task overhead information corresponding to each calculation task cluster by clustering the plurality of historical calculation tasks based on task-related information of the plurality of historical calculation tasks;
determining a preferred calculation task cluster matching the calculation tasks based on task-related information of the calculation tasks; and
determining the workload information of the calculation tasks based on task overhead information of the preferred calculation task cluster.

10. An apparatus comprising:
a first device configured to receive, from a cluster, a plurality of calculation tasks to be scheduled; and
a second device configured to divide the plurality of calculation tasks into a plurality of task subsets based on workload information corresponding to the plurality of calculation tasks, wherein each of the task subsets is assigned to a node of the cluster.

11. The apparatus of claim 10, further comprising:
a third device configured to allocate a task subset to a corresponding assigned node of the cluster and perform, in the corresponding assigned node of the cluster, the calculation tasks in the task subset.

12. The apparatus of claim 10, wherein the second device is configured to:
divide the plurality of calculation tasks into a plurality of task subsets based on workload information corresponding to the plurality of calculation tasks and node resource threshold information corresponding to the cluster, wherein each of the plurality of task subsets is assigned to a node of the cluster.

13. The apparatus of claim 12, wherein the second device is configured to:
perform a dividing operation based on workload information corresponding to the plurality of calculation tasks and node resource threshold information corresponding to the cluster until the plurality of calculation tasks are divided into a plurality of task subsets, wherein each of the plurality of task subsets is assigned to a node of the cluster, wherein the dividing operation comprises:
selecting one of the calculation tasks to be divided in the plurality of calculation tasks to serve as a first calculation task;
determining one or more candidate task subsets, wherein the candidate task subset comprises the first calculation task and at least one of the other calculation tasks to be divided in the plurality of calculation tasks, and the accumulated information of workload information of the calculation tasks in the candidate task subset satisfies the node resource threshold information; and
determining the task subset from the one or more candidate task subsets.

14. The apparatus of claim 13, wherein determining the task subset from the one or more candidate task subsets comprises:
determining task subset-related information of the candidate task subset; and
determining the task subset from the one or more candidate task subsets based on the task subset-related information.

15. The apparatus of claim 13, wherein the accumulated information of workload information of the calculation tasks in the candidate task subset satisfies the node resource threshold information comprises: the accumulated information of the workload information of the calculation tasks in the candidate task subset respectively satisfying the node resource threshold information in terms of dimension.

16. The apparatus of claim 10, wherein the second device is further configured to:
determine task overhead information of a plurality of historical calculation tasks based on task computing log information of the cluster; and
determine workload information of the calculation tasks based on the task overhead information of the plurality of historical calculation tasks.

17. The apparatus of claim 16, wherein determining workload information of the calculation tasks based on the task overhead information of the plurality of historical calculation tasks comprises:
screening out a historical calculation task matching the calculation tasks from the plurality of historical calculation tasks based on task-related information of the calculation tasks; and
determining the workload information of the calculation tasks based on task overhead information of the historical calculation task.

18. The apparatus of claim 16, wherein determining workload information of the calculation tasks based on the task overhead information of the plurality of historical calculation tasks comprises:
determining task overhead information corresponding to each calculation task cluster by clustering the plurality of historical calculation tasks based on task-related information of the plurality of historical calculation tasks;
determining a preferred calculation task cluster matching the calculation tasks based on task-related information of the calculation tasks; and
determining the workload information of the calculation tasks based on task overhead information of the preferred calculation task cluster.
